(19) United States
(12) Patent Application Publication
(10) Pub. No.: US 2005/0138559 A1
(43) Pub. Date: Jun. 23, 2005

(54) Method, system and computer program for providing interactive assistance in a computer application program

(75) Inventors: Lucinio Santos-Gomez, Durham, NC (US); Jessica J. Peter, Apex, NC (US); David Kirk Grotjohn, Cary, NC (US)

Correspondence Address: SYNNESTVEDT & LECHNER, LLP, 2600 ARAMARK TOWER, 1101 MARKET STREET, PHILADELPHIA, PA, 191072950, US

(73) Assignee: International Business Machines Corporation, Armonk, NY (US)

(21) Appl. No.: 10/741,468

(22) Filed: Dec. 19, 2003

(51) Int. Cl. G06F 3/00

(52) U.S. Cl. 715/709; 715/705; 715/706; 715/707; 715/708; 715/711; 715/712; 715/713; 715/714; 715/715

(57) ABSTRACT

Provided are methods for providing assistance to the user of a computer application program having a main user interface window, the methods comprising the steps of: determining when a user needs assistance to perform a program task; contextually displaying an assistance panel within the main user interface window which panel describes a user step to be conducted to perform a next task step; and detecting the user step conducted to perform the described task step while the assistance panel is displayed within the main user interface window. Also provided are systems and computer program products for implementing the methods of the present invention.

### FIELD OF INVENTION

The present invention relates to personal computer systems and, more particularly, to a method, system, and computer program product for providing interactive user assistance in the main graphical user interface (GUI) of an application program, and the use thereof.

### BACKGROUND

In recent years, virtually all personal computers and workstations have adopted a graphical user interface (GUI) environment, which allows a user to manage the computer system and execute applications using a “point-and-click” method on objects shown on the computer display and/or in application windows. As a result, the vast majority of software applications developed for use on such computer systems tend to be “window-based” applications, often comprising a primary or main user interface window wherein key software functions are performed, and, optionally, one or more child or adjunct windows. Examples of window-based software applications in current use include Microsoft's Windows XP and Windows 2000.

Due to the wide variety of tasks capable of being executed on today's software, most window-based software applications are developed with some form of “help” system designed to assist a user in executing any of a variety of single or multi-step functions within or from a main user interface window. Examples of conventional help-systems include standard help window systems, system wizards, tutorials, and coaches.

Standard help window systems are typically separate from the software products for which they offer help, and operate by opening a help window, separate from the main user interface window, wherein instructions (often a list of steps) for executing an application task in the main user interface window are retrieved (often via a search function or by paging through lists of help topics) and displayed for the user. Upon review of the help instructions in the help window, a user then moves from the help window to the main user interface window to perform, within the main user interface window, the steps described in the help window.

Applicants have recognized, however, that such standard help systems are disadvantageous for several reasons. One disadvantage is that such help systems fail to provide contextual assistance within a main user interface window to visually guide a user to the areas of the main user interface window where user interaction(s) is/are required to execute a task in the main application. While such separate assistance windows may provide textual descriptions, and even visual representations, of icons, objects, or areas of the main interface where user interaction is required to perform a task (i.e. click “print” icon or “tools”), in the absence of some contextual help on the main interface in the location of the icon/interaction area, a user unfamiliar with the application interface is left to move from the assistance window to the main interface and search the main interface window for the icons, objects, etc. to be interacted with.

Another disadvantage is that, in certain standard help systems, a user cannot execute a given step within the main user interface while the assistance window is displayed and viewable by the user. That is, to “move” from the help window to the main user interface to execute a step following certain typical help system procedures, a user is required to exit the help window, either by closing such window or by first clicking on the main user interface window, which first click acts to automatically “hide” the help window behind the main user interface window, as is known in the art. Only after the assistance window is closed or hidden can the user then interact with the main user interface window to execute a user step. Accordingly, because many standard help systems do not allow the assistance window to be displayed while the steps described therein are executed in the main user interface window, a user must either remember all the user steps described in the assistance window and then move to the main interface window to execute all of such steps, or a user must repeatedly move between the assistance window and the main user interface window to alternately review, then execute, the user steps to perform an application task.

Wizards provide a closed system wherein a user is guided through a series of windows outside of the main user interface to perform an application task. Typically, the wizard windows provide a description of a task to be performed and ask for authorization from the use to perform such task. Upon authorization, the task is performed by the wizard, without providing the user an opportunity to interact with the main user interface until after the task is completed and the wizard system closed. Further, in such systems, users are not provided any contextual guidance, or other assistance, for performing user steps or tasks within a main user interface.

Many conventional tutorial modes operate in an adjunct window, apart from the main user interface, which displays a mock-up representation of the main user interface. Contextual user assistance is then provided within the adjunct window, which illustrates relative areas in the mock-up where similar user interaction is required on the main user interface window to achieve the application task. For example, a three-step task may be illustrated by highlighting three icons on the mock-up to be subsequently activated in sequence by the user within the main user interface. However, such help is still not given in within the specific context of the actual main user interface window, and a user cannot actually execute the illustrated steps while in the tutorial mode. Rather, the user is required to remember the highlighted steps, exit the tutorial mode, and move to the main user interface prior to executing the user steps.

Certain other help systems, including coaches and certain tutorials provide assistance on the main user interface. However, such help is still dissociated from the execution of the desired user steps and tasks on the main interface in that the help provided is not contextually displayed within the main interface and/or a user is required to exit one or more help windows or help modes before the tasks described therein can be executed.

Accordingly, applicants have recognized the need to provide a method, system, and computer program which overcomes the disadvantages of conventional help systems.

### SUMMARY OF THE INVENTION

The present invention overcomes the aforementioned disadvantages by providing a method for assisting a user to execute a task in a program application, which method allows the user to interact with, and execute one or more steps to complete the desired task on, a main user interface while assistance information describing each one or more steps to be executed is displayed contextually on the main interface window. By allowing the user to execute steps on the main user interface while assistance information describing each step is displayed within the same main interface, the present methods facilitate the execution user steps, and the resulting application tasks, while avoiding the extraneous user time associated with exiting one or more assistance modes and/or moving between one or more separate help windows and the main user interface. In addition, the contextual display of information within the main user interface window according to the present invention more quickly directs a user to key objects in the main user interface that need be interacted with to perform a given step. A user can readily learn how to execute, and actually execute, in a step-by-step manner, the steps required to complete a desired application task, including a high-level multi-step task, within the main interface window in a manner that is more direct and less likely to cause confusion to the user.

Accordingly, in certain preferred embodiments, the present invention thus provides a method of providing assistance to the user of a computer application program having a main user interface window, the method comprising: determining when a user needs assistance to perform a program task; and contextually displaying an assistance panel within the main user interface window which describes a user step to be executed to perform the program task and allows the user to execute such step within the main user interface while the assistance panel is displayed within the main user interface window.

According to certain other preferred embodiments, a system and a computer program product for carrying out the inventive method are also provided.

### BRIEF DESCRIPTION OF THE DRAWINGS

FIG. 1 is a flowchart of steps followed in implementing an embodiment of the present invention.

FIGS. 2-7 show screen captures of a main user interface window of an application program, each screen capture further showing a contextually displayed assistance panel according to one embodiment of the present invention.

FIG. 8 is a flowchart of steps followed in implementing an embodiment of the present invention.

### DESCRIPTION OF PREFERRED EMBODIMENTS

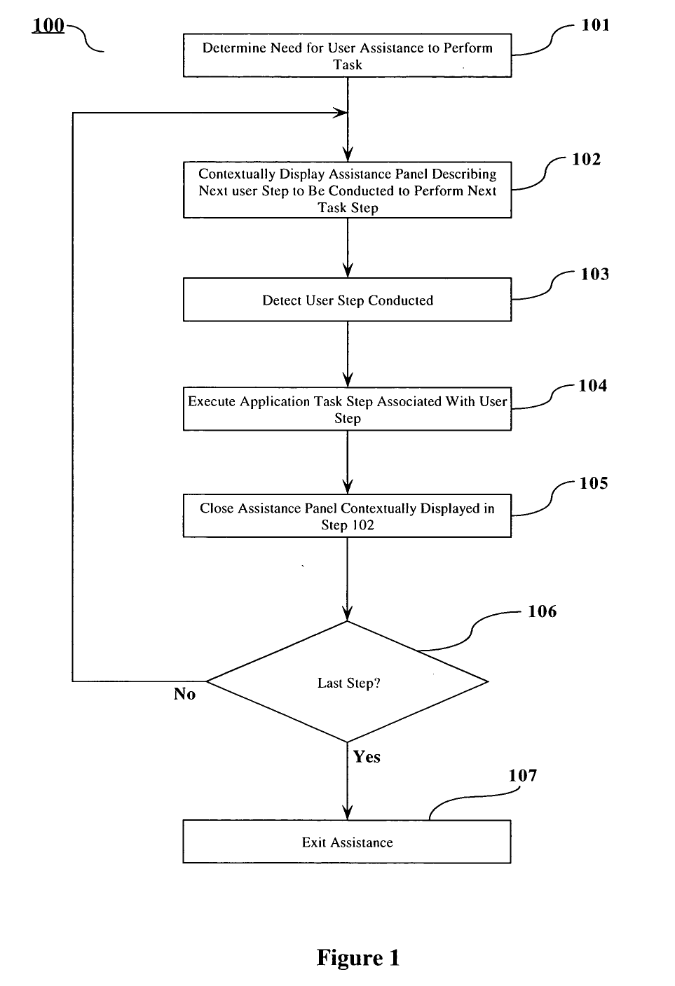

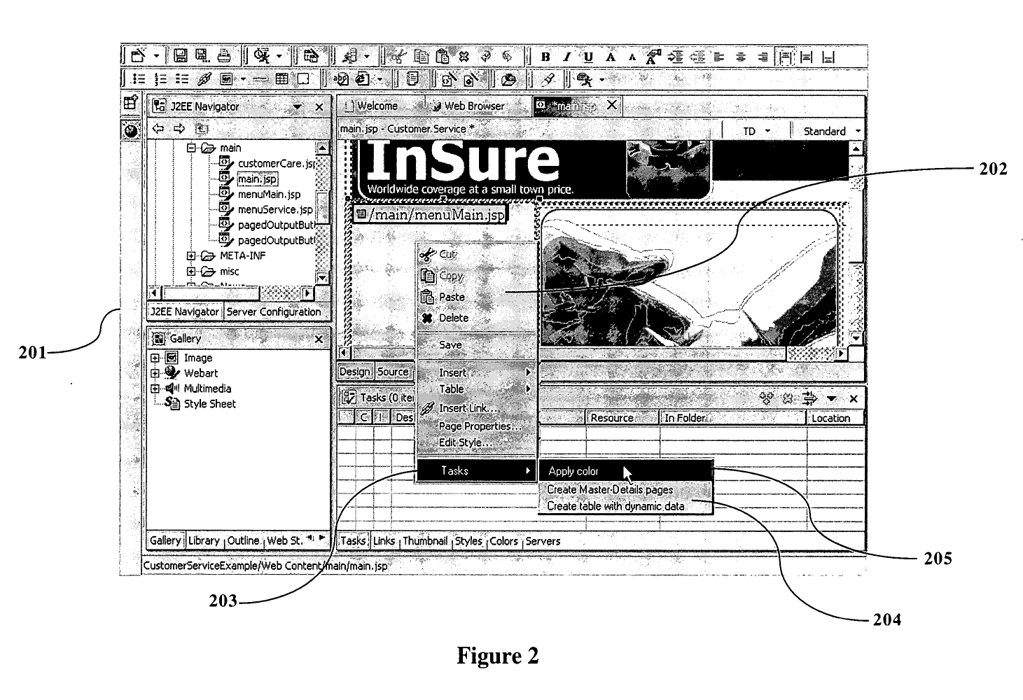

FIG. 1 is a flowchart 100 of steps followed in implementing an embodiment of the present invention. As shown in FIG. 1, the method starts with the step of determining the need for user assistance to perform an application task in a main user interface window 101. Any suitable means for determining the need for user assistance to perform a task may be adapted for use in the present invention. For example, in certain embodiments, the need for assistance may be determined by detecting a user event such as a mouse event, including a mouse-click at a particular location on the application user interface, or input from a computer keyboard, such as the use of a particular “function”, or other, key. As will be readily understood by those of skill in the art, any particular clickable location, or sequence of clickable locations, on an application user interface, or any sequence of one or more keyboard input(s) can be assigned to designate a need for user assistance according to the present method. In certain embodiments, for example, a determination that user assistance is needed is made when a “help” button is clicked. In certain preferred embodiments, the determination to provide assistance for a particular task may be made by detecting the initiation of such task in the program application by the user (either by mouse click or keyboard input). For example, FIG. 2 shows a screen capture of a main user interface window 201 of a software application as it might be displayed on a typical computer system. A drop-down menu 202 is seen in a selected state, with the selection of a “tasks” option 203 causing drop-down menu 204, listing selectable tasks to be performed, to be displayed. Selection of a particular task to be performed, i.e. the “apply color” task 205 selected in FIG. 2 initiates the “apply color” mode of the program application. In certain embodiments, the initiation of such task mode further designates a determination that assistance is needed, and initiates assistance within the main user interface of the program application according to the present invention.

In certain other embodiments of the present invention, the need for user assistance may be determined by a user's mouse entering a particular location on the screen and/or pausing in such location for a designated period of time. Any suitable method for detecting a mouse location or mouse hovering event known in the art can be adapted for use in the determining step of the present invention. In light of the disclosure herein, those of skill in the art will be readily able to provide any of a variety of means for determining the need for user assistance for use in the present invention without undue experimentation.

Referring back to FIG. 1, upon determination that user assistance is required to perform a task according to step 101, an assistance panel describing the next step to be executed by the user to perform the task is contextually displayed within the application main user interface window according to step 102.

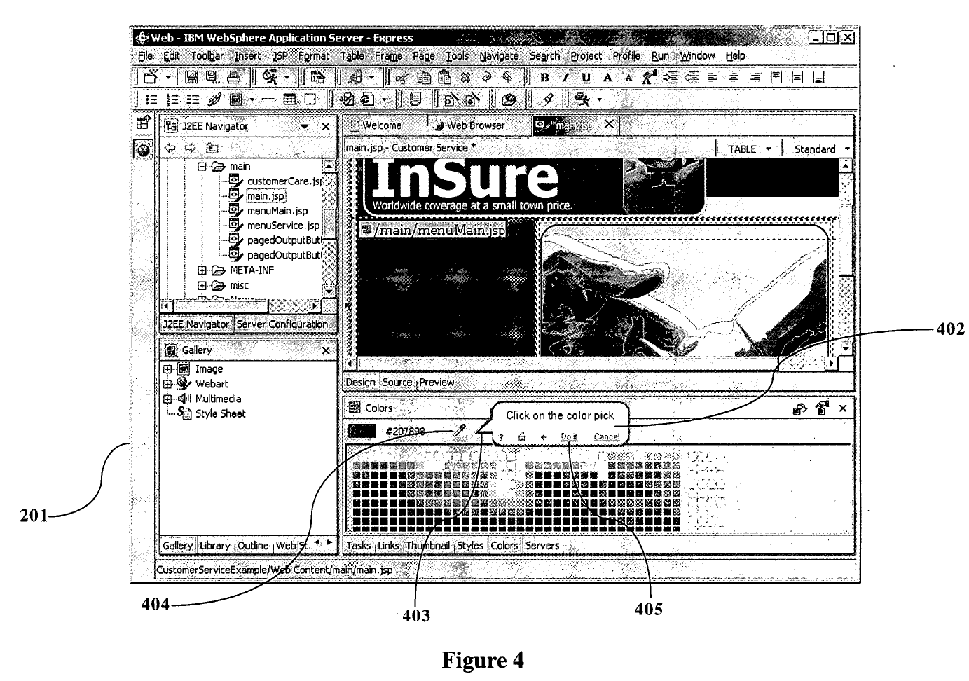

As used herein, the term “contextually displayed within the application main user interface window” refers to an assistance panel which is displayed: (a) within the two-dimensional space defined by a main user interface window; and is (b) placed within such space such that at least a portion thereof is overlapping, touching, or adjacent to, in a two-dimensional sense, an image, object, or particular area of the main user interface window where a user is required to interact to perform the step described in the assistance panel. In certain preferred embodiments, a contextually displayed assistance panel comprises an assistance panel which, in a two-dimensional sense, overlaps or touches the image/object/area of the main interface window where user interaction is required to perform the step described in the panel. In certain other preferred embodiments, a contextually displayed assistance panel comprises an assistance panel which, in a two-dimensional sense, is adjacent to the image/object/area of the main interface window where user interaction is required to perform the step described in the panel. Illustrative examples of contextually displayed assistance panels are shown in FIGS. 4-7, discussed in more detail below. Namely, such figures show assistance windows 402, 502, 602, and 702, respectively, contextually displayed within main user interface window 201.

Any means for contextually displaying an assistance panel according to step 102 of the present invention may be adapted for use herein. In certain preferred embodiments, this step may involve, for example, the steps of: (a) determining, via any of a variety of known methods, information relative to the task to be performed, the user steps to be executed to perform such task, and information defining various aspects of an assistance panel to be displayed for each user step, such as, the location within the user interface window where the panel is to be contextually displayed for the step, the shape and size of the assistance panel, and the content to be displayed in the assistance panel; and (b) displaying an assistance panel based on such determining step (a). For example, in certain preferred embodiments, the contextually displaying step 102 comprises the steps of retrieving a model for the task to be performed (“task X”), comprising all the user steps required to perform the overall task, descriptions of the steps, locations for displaying panels describing the steps, as well as, the sizes and shapes of each panel to be displayed, from a task model repository, and displaying one or more assistance panels based on the information retrieved from the model repository. In certain embodiments, the contextually displaying step further comprises communicating with the host application program (having the main user interface window) to adjust the main user interface window in some manner to allow an assistance panel to be properly contextually displayed. For example, if a user step to be performed in the sequence of steps necessary to perform a task is to be carried out (for example, via user interaction with a clickable object) in a dialog box of the main user interface, the contextually displaying step may comprise communicating with the host application to open the appropriate dialog box and then displaying an assistance panel in the appropriate context within the dialog box. In such embodiments, the contextually displaying step may comprise (i) determining, via any of a variety of known methods, information relative to the task to be performed, the user steps to be executed to perform such task, and information defining various aspects of an assistance panel to be displayed for each user step, such as, the location within the user interface window where the panel is to be contextually displayed for the step, the shape and size of the assistance panel, and the content to be displayed in the assistance panel; (ii) communicating with the application main user interface to adjust the main user interface window for contextually displaying the assistance panel therein, and (iii) displaying an assistance panel based on such determining step (i). In light of the description herein, those of skill in the art will be readily able to provide appropriate software code for storing and retrieving information to contextually display an assistance panel within a main user interface window based on such information without undue experimentation.

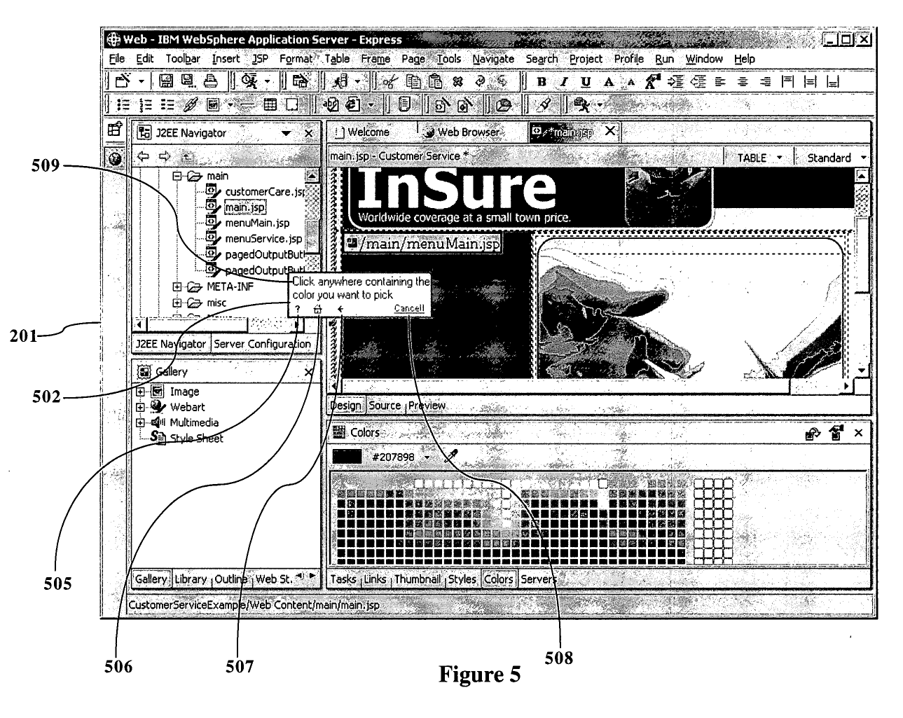

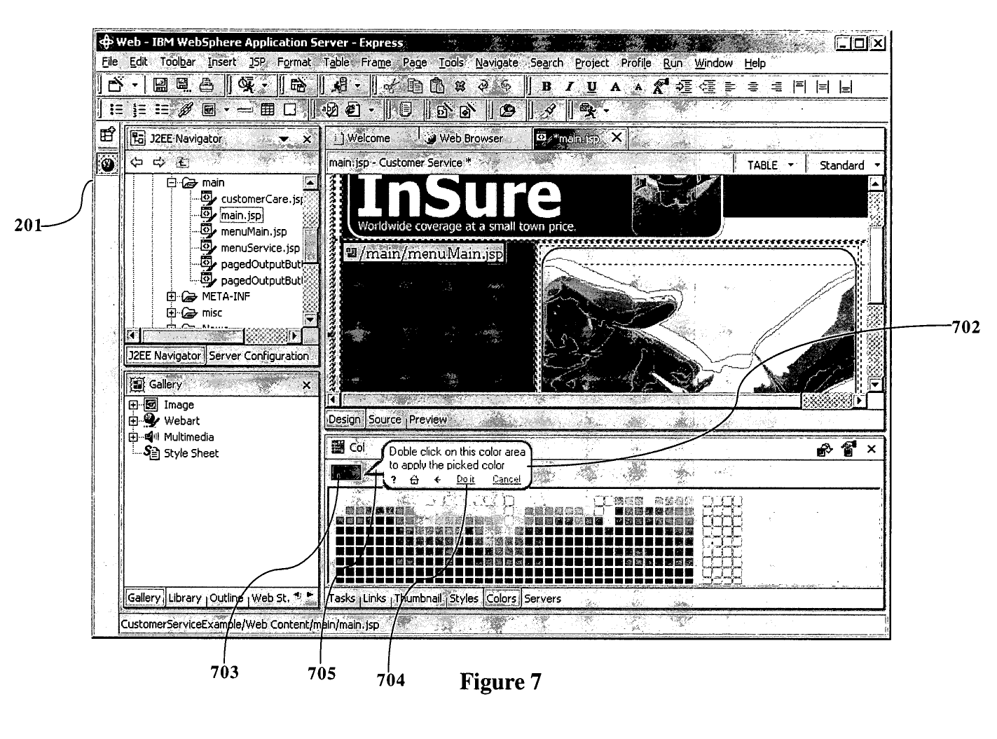

As indicated above, each contextually displayed panel comprises at least a description of the next user interaction to be conducted to perform the program task. In addition to such content, each assistance panel may further comprise one or more objects with which a user can interact to perform one or more desired functions. For example, as shown in FIG. 5, the contextually displayed panel 502 comprises not only a description of the next user interaction to be executed 509, but also displays a “help” object 505, a “home” object 506, a “page back” object 507 and a “cancel” object 508 which are clickable objects associated with one or more particular application or help system functions. For example, a click on the help object 505 opens a standard help window offering standard help instructions and options. That is, the help object acts as a link to further help materials that may or may not be part of the present assistance methods (such as a separate conventional help window system described above). A click on the home object 506 takes the user back to the first step of the assistance system for a given task and allows the user to start the assistance and user task from the first step, a click on the page back object 507 backs the assistance up one step/panel and allows a user to redo such step, a click on the cancel object 508 cancels the assistance system at that point. In certain preferred embodiments, the assistance panels according to the present invention further comprise an object that can be mouse-clicked to perform the described user interaction, as an alternative to clicking the designated object/area within the main user interface. For example, the assistance panel 702 in FIG. 7 indicates contextually a color area 703 to be clicked to perform a color application task. In addition, panel 702 comprises a “Do it” object 704 which can be clicked instead of color area 703 to perform the desired step. In this manner, the preferred embodiments of the present invention provide a more versatile, and simple method for assisting a user to perform an application task.

Each assistance window contextually displayed according to the present invention may be of any suitable size and shape for a given application. Preferably, the size and shape of a displayed window are selected to clearly describe to a user the next user step to be executed and, optionally, to provide some indication as to where within the main interface the next user interaction is required to perform the next user step. In certain embodiments, an assistance window of the present invention is preferably large enough to display, in a desired font and font size (preferably selected to be legible to an average user), a text description of the next user step to be executed, as well as, any other text, objects, or other information to be shown therein. At the same time, in certain applications, it is preferred that the assistance window comprise as little space of the main interface window as possible, to avoid covering important information and valuable window space. Those of skill in the art will be readily able to determine the assistance window size desired for a given application and to display a window of such size according to the present invention without undue experimentation.

The shape of the assistance window may be selected for any given application to function merely to surround the desired content to be displayed therein, or optionally, the window may be shaped to direct the user's attention to a particular portion of the main interface. For example, a portion of the assistance window may be tapered, and especially, tapered to a point which indicates an area on the main interface window where user input is required to execute the described user step. FIGS. 4, 6, and 7 show exemplary assistance panels 402, 602, and 702 that comprise tapered portions 403, 603, and 705, respectively, each of which points to an icon/object/area wherein user input (a mouse click) is required to execute the described user step. In such embodiments, the window is preferably contextually displayed such that the tapered point or other means for indicating an interface area is adjacent to, touches or overlaps the icon/object/area indicated.

In certain preferred embodiments, appropriate software code is provided such that the contextually displayed assistance panel of the present invention is an overlay graphic which, in a three-dimensional sense, is located in a “plane” or “layer” nearer to the user than the “plane” or “layer” of the main user interface window. That is, as will be recognized by those of skill in the art, the view in the work area of a GUI, such as the main user interface window of the present invention, may be perceived in a three-dimensional sense as a series of layers, with certain objects being in the nearest plane or layer relative to the user and the remaining objects occupying layers or planes “beneath” (i.e., deeper) in the work area. Just like a physical desktop of a desk, when an object is in the nearest plane, it overlaps (covers) the other objects underneath it, thereby obstructing the view of some or all of the object(s) underneath. In the preferred embodiments of the present invention, by presenting the assistance panels of the present invention as overlays, the assistance panels can be readily displayed over a main user interface window to appear, in a two-dimensional sense, in any desired context within the main user interface window.

In certain preferred embodiments of the present invention, appropriate software code is employed so that the assistance panels remain in their relative two-dimensional contexts within the main user interface window upon adjustment in size or location of the main user interface window. That is, as a main user interface window is increased or decreased in size (for example, the window is maximized or reduced), an assistance panel contextually displayed therein preferably increases or decreases in size to the same degree such that the relative size of the assistance window as compared to the main user interface window remains approximately the same. In addition, as the main user interface window is moved around a computer GUI screen, the assistance panel preferably moves with the main user interface to maintain the same relative two-dimensional position therein.

As indicated in FIG. 1, the present method further comprises the step 103 of detecting a user event for executing the step described in the assistance window displayed according to step 102, while such assistance window is contextually displayed within the main user interface window (i.e. detection is done prior to removing the displayed assistance window in step 105, discussed below). Any appropriate program code suitable for detecting a user event, such as a mouse click within the main user interface, may be adapted for use in the present detection step. In certain preferred embodiments, the present methods comprise detecting when and which step is being executed by the user through the host application program's even handling interfaces, as will be understood by those of skill in the art.

As indicated in FIG. 1, in preferred embodiments, after detecting a user event in step 103, the present invention comprises the steps (104, 105) of executing the step associated with the user event (i.e. the step described in the displayed assistance panel) and closing the contextually displayed assistance panel, respectively. Upon detection in step 103, steps 104 and 105 of the present invention may occur either sequentially, simultaneously, or substantially simultaneously. As used herein the term “substantially simultaneously” refers to two methods steps (for example steps 104 and 105 of the present invention), conducted in any order, having a time delay therebetween of from greater than zero to about one second, preferably from greater than zero to about 0.5 seconds, and more preferably from greater than zero to about 0.1 seconds. As illustrated in FIG. 1, certain preferred methods of the present invention comprise the sequential steps of executing the step 104 and closing the contextually displayed window 105, in that order. Those of skill in the art will be readily able to provide appropriate program code suitable for communicating with the host program application and executing the initiated user step in the application upon detection of user event in step 103.

In certain other embodiments, applicants note that the contextually displayed panel from step 102 may be closed, and optionally replaced with another panel, prior to execution of the desired user step. For example, in certain embodiments a user step may take some noticeable time to execute within the host application. In this case, in certain embodiments, the displayed panel may be closed and replaced with a next panel indicating “Task being executed. Please wait” or the like. Alternatively, if there is an internal problem in executing the desired step, and error panel (i.e. “Error, please try again”) may be displayed over the panel displayed in step 102 or replace such panel (upon closing of the panel from step 102).

The methods of the present invention are suitable for use in assisting users to conduct single- or multiple-step tasks. Referring to FIG. 1, in single-step tasks, once the contextually displayed panel from step 102 is closed in step 105 after performing the task in step 104, the last step has been conducted (as determined in 106) and thus the assistance system is exited at step 107.

In certain preferred embodiments, the methods of the present invention comprise methods for assisting users to perform a multi-step task. Referring to FIG. 1, after a step which is not the last step in a multi-step task is executed in 104 and the displayed assistance panel for such step removed in 105, a determination is made at 106 that the step executed is not the last step and the method returns to step 102 to contextually display the next (typically different) step in an assistance panel. Preferably, in such embodiments, the step contextually displaying the assistance panel for the next step occurs subsequently or substantially simultaneously with the closing step 105 of the previously displayed assistance panel. After the next assistance panel is displayed, the method comprises repeating steps 103-106 for the next step. Such cycle may repeat for as many steps as necessary to perform a multi-step task according to the present invention. After the last step has been executed, the assistance system is exited as described above according to step 107.

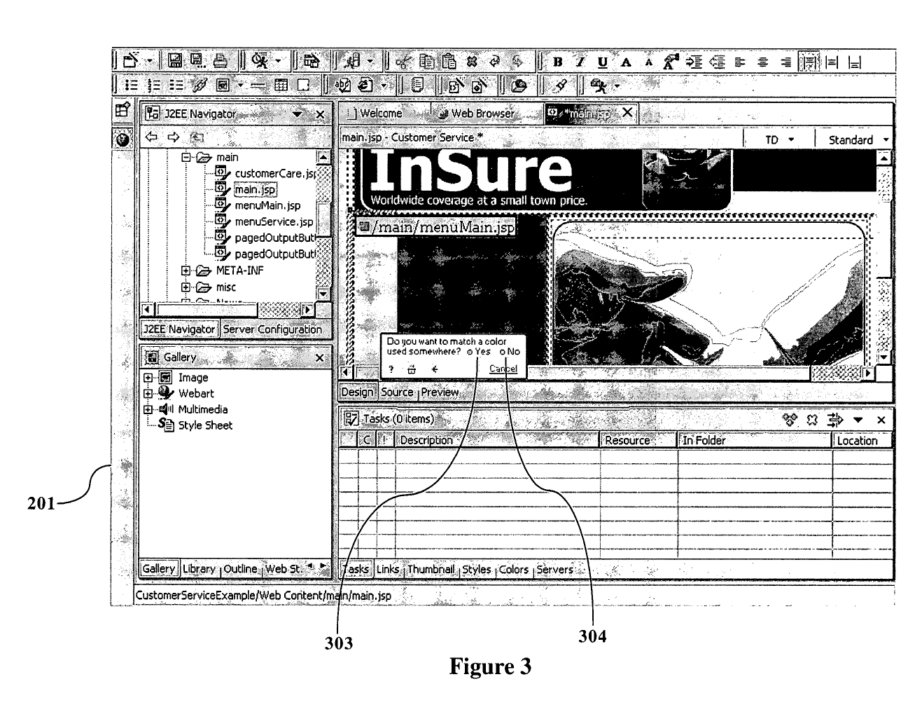

By way of example, and without intending to be limiting, the execution of a multi-step task (“apply color”) using the assistance methods of the present invention is illustrated from a user's point-of-view with reference to FIGS. 2-7, in sequence. As described above, FIG. 2 shows a screen capture of a main interface of a host application wherein initiation of the “apply color” task is selected from a series of drop-down menus. Upon initiation of the task, a determination for assistance is made and, as shown in FIG. 3, a first assistance panel 302 appears within the context of main user interface window 201. Assistance panel 302 asks a user, according to one option in the apply color task, whether the user wants to match a color used elsewhere, and provides clickable “yes” 303 and a “no” 304 areas for answering the question. A user click on either of the “yes” 303 or “no” 304 objects results, from the user's point-of-view, in a display of the next appropriate assistance panel.

As shown in FIG. 4, after the “yes” object 303 is clicked, assistance panel 302 is closed and the next assistance panel 402, having a tapered point 403, is contextually displayed within interface window 201. That is, panel 402 is placed such that the entire window, and in particular the tapered point 403, is adjacent to the “color pick” object 404 to be clicked in the described step. Panel 402 further comprises a “Do it” object 405 which allows a user to optionally click such object to affect the same step execution as if the color pick object 404 had been clicked.

With reference to FIG. 5, upon a user mouse-click on either of the color pick object 404 or the “Do it” object 405, the assistance panel 402 is closed and the next assistance window 502 describing the next user step is contextually displayed on interface window 201. Assistance panel 502 instructs the user to click an area on the main interface window 201 containing the color to be picked.

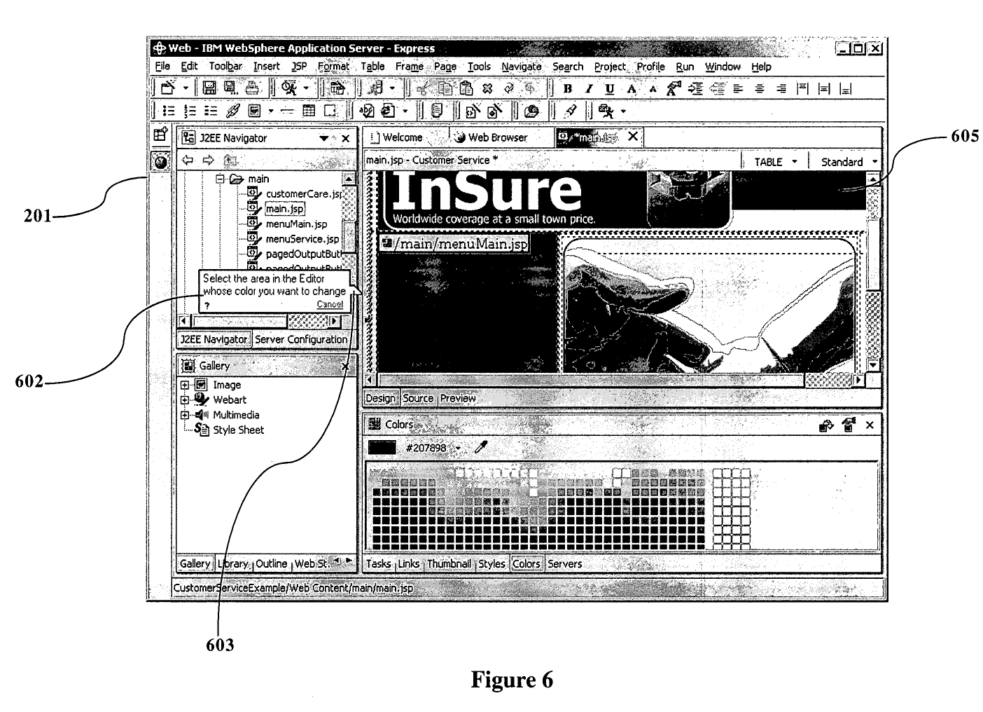

Referring to FIG. 6, upon a user mouser-click of an area of window 201 in FIG. 5 to select the color thereof, assistance panel 502 is closed and new assistance panel 602, describing the next step, is contextually displayed within main window 201. In such contextually displayed panel 602, the tapered portion 603 is placed adjacent to the “Editor” portion 605 of the main window 201 wherein a selection needs to be made by the user.

Referring to FIG. 7, upon a selection by mouse-click of an area in FIG. 6, assistance panel 602 is closed, and new assistance panel 702, describing the final step of the task is contextually displayed. Assistance panel 702 indicates a color area 703 within the main window 201 which may be clicked to apply the selected color. Optionally, panel 702 comprises a “Do it” object 704 which can be mouse-clicked to execute the application step. Upon a mouse-click by the user on area 703 or object 704, the application step is executed and the assistance system exited.

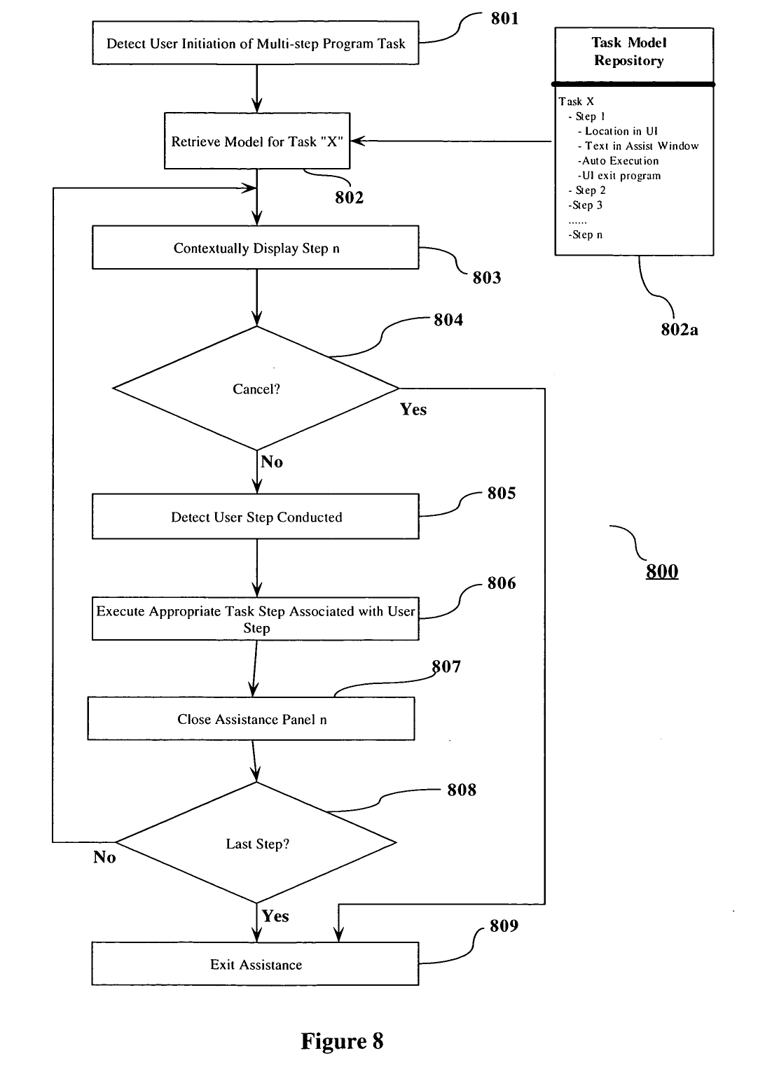

By way of further example, FIG. 8 shows a flow chart 800 of the steps to be implemented according to certain preferred embodiments of the present method. As shown in FIG. 8, the first step of the illustrated embodiment comprises detecting the initiation of a program task (“task X” as shown) by the user 801. In such embodiments, the determination of need for assistance is made merely upon initiation of a multi-step program task within the host program application. Upon detection in step 801, the next step comprises retrieving a model for task×802 from a model repository 802a, from which model it is determined the number (1 to n) and sequence of user steps required to perform task X, as well as, the content to be displayed within an assistance panel associated with each step, and the context within the main user interface where the panel for each step is to be displayed. Once the model for task X is retrieved in step 802, an assistance panel describing the first user step (n=1) is contextually displayed 803 in the main user interface based on the information determined in step 802. In the embodiment illustrated by FIG. 8, the assistance window comprises an object with which the user may interact to cancel the assistance system prior to conducting the described user step. Accordingly, as shown in step 804, if the user chooses to cancel, the assistance mode is exited. If the mode is not exited and the user step conducted, such conducted step is detected at step 805 and the task application associated with the user step is executed at step 806. In the illustrated embodiment, after the task step is executed, the first assistance panel (n=1) is closed in step 807. If the first step (n=1) is the last step, the system is exited. If not, then n becomes n+1 and the assistance panel for the second step (n=2) is displayed in step 803. These steps are then repeated for each step of the task (1 through n), provided the user does not cancel (804) during the display of a panel, until all steps are executed and the task completed.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage of some type, such as permanent storage of a computer running a GUI configured to include the present invention. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, the figures support combinations of means for performing the specified functions, combinations of steps for performing the specified functions, and program instruction means for performing the specified functions.

While there has been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

1. A method of providing assistance to the user of a computer application program having a main user interface window, the method comprising the steps of:
(a) determining when a user needs assistance to perform a program task;
(b) contextually displaying an assistance panel within the main user interface window which panel describes a user step to be conducted to perform a program task; and
(c) detecting the user step conducted to perform the described task step while the assistance panel is displayed within the main user interface window.

2. The method of claim 1 wherein said determining step comprises detecting the initiation of a particular task to be performed in the main user interface window.

3. The method of claim 1 wherein said contextually displaying step (b) comprises the steps of (i) determining the content to be displayed in the assistance panel and the position within the main user interface wherein the assistance panel is to be displayed, and (ii) displaying the assistance panel based on said determination (i) step.

4. The method of claim 1 wherein said contextually displaying step (b) comprises the steps of (i) determining the content to be displayed in the assistance panel and the position within the main user interface wherein the assistance panel is to be displayed, (ii) communicating with the application main user interface to adjust the main user interface window for contextually displaying the assistance panel therein, and (iii) contextually displaying the assistance panel within the main user interface window based on said determination (i) step.

5. The method of claim 1 wherein said contextually displayed assistance panel is adjacent to an object to be interacted with by a user to perform the step described in the assistance panel.

6. The method of claim 1 wherein said assistance panel comprises a help object susceptible to user input that opens a new help window upon being activated.

7. The method of claim 1 wherein said assistance panel comprises a cancel object susceptible to user input that cancels the present assistance method upon being activated.

8. The method of claim 1 wherein said assistance panel comprises a home object susceptible to user input that returns the assistance method to a designated home assistance panel upon being clicked.

9. The method of claim 1 wherein said assistance panel comprises a “page back” object susceptible to user input that returns the assistance method to a previous assistance panel upon being clicked.

10. The method of claim 1 wherein said assistance panel comprises an object susceptible to user input that conducts the described user step from within the assistance panel upon being clicked.

11. The method of claim 1 wherein at least a portion of said assistance panel tapers to a point which is adjacent to an object to be interacted with by a user to perform the described user step.

12. The method of claim 1 wherein said assistance panel maintains its relative size to the main user interface window upon resizing of the main user interface window.

13. The method of claim 1 wherein said assistance panel maintains its relative position within the main user interface window upon movement of the main user interface window within a computer GUI display.

14. The method of claim 1 further comprising the step of executing an application step associated with the detected user step.

15. The method of claim 13 further comprising the step of closing the contextually displayed assistance panel.

16. The method of claim 14 wherein said executing step is performed prior to said closing step.

17. The method of claim 14 wherein said executing and closing steps are performed substantially simultaneously.

18. The method of claim 14 further comprising the step of contextually displaying an assistance window within the main user interface describing a next user step to be conducted to perform the program task.

19. A method of providing assistance to the user of a computer application program having a main user interface window, the method comprising the steps of:
(a) detecting initiation by a user of a multi-step program task;
(b) determining the user steps, and sequence thereof, to be performed by the user to complete the multi-step program task;
(c) for each user step determined in step (b), determining content to be displayed in an assistance panel associated therewith and the context within the main user interface wherein the assistance panel is to be displayed;
(d) displaying in sequence and in context at least two assistance panels within the main user interface window based on the sequence and context determined in steps (b) and (c), wherein each user step described in an assistance panel is capable of being conducted by the user while the assistance panel is displayed within the main user interface, and the conducting of such step by the user initiates: (i) execution of such step in the main user interface, (ii) closing of the displayed assistance panel, and (iii) the contextual display of the assistance panel associated with the next user step in the determined sequence.

20. A system for providing assistance to the user of a computer application program having a main user interface window, the system comprising:
(a) means for determining when a user needs assistance to perform a program task;
(b) means for contextually displaying an assistance panel within the main user interface window which panel describes a user step to be conducted to perform a program task; and
(c) means for detecting the user step conducted to perform the described task step while the assistance panel is displayed within the main user interface window.

21. A system for providing assistance to the user of a computer application program having a main user interface window, the system comprising:
(a) means for detecting initiation by a user of a multi-step program task;
(b) means for determining the user steps, and sequence thereof, to be performed by the user to complete the multi-step program task;
(c) means for determining, for each user step determined by means (b), content to be displayed in an assistance panel associated therewith and the context within the main user interface wherein the assistance panel is to be displayed;
(d) means for displaying in sequence and in context at least two assistance panels within the main user interface window based on the sequence and context determined by means (b) and (c), wherein each user step described in an assistance panel is capable of being conducted by the user while the assistance panel is displayed within the main user interface, and the conducting of such step by the user initiates: (i) execution of such step in the main user interface, (ii) closing of the displayed assistance panel, and (iii) the contextual display of the assistance panel associated with the next user step in the determined sequence.

22. A computer program product for providing assistance to the user of a computer application program having a main user interface window, the product comprising:
(a) computer readable code for determining when a user needs assistance to perform a program task;
(b) computer readable code for contextually displaying an assistance panel within the main user interface window which panel describes a user step to be conducted to perform a program task; and
(c) computer readable code for detecting the user step conducted to perform the described task step while the assistance panel is displayed within the main user interface window.

23. A computer program product for providing assistance to the user of a computer application program having a main user interface window, the product comprising:
(a) computer readable code for detecting initiation by a user of a multi-step program task;
(b) computer readable code for determining the user steps, and sequence thereof, to be performed by the user to complete the multi-step program task;
(c) computer readable code for determining, for each user step determined by computer readable code (b), content to be displayed in an assistance panel associated therewith and the context within the main user interface wherein the assistance panel is to be displayed;
(d) computer readable code for displaying in sequence and in context at least two assistance panels within the main user interface window based on the sequence and context determined by computer readable code (b) and (c), wherein each user step described in an assistance panel is capable of being conducted by the user while the assistance panel is displayed within the main user interface, and the conducting of such step by the user initiates: (i) execution of such step in the main user interface, (ii) closing of the displayed assistance panel, and (iii) the contextual display of the assistance panel associated with the next user step in the determined sequence.
